(19) United States
(12) Patent Application Publication
(10) Pub. No.: US 2014/0379593 A1
(43) Pub. Date: Dec. 25, 2014

(54) MANAGING TRUSTED RELATIONSHIPS AMONG PARTIES ASSOCIATED WITH A LICENSE FOR USING A COMPUTER PRODUCT

(71) Applicant: CISCO TECHNOLOGY, Inc., San Jose, CA (US)

(72) Inventors: Steve KOEHLER, San Jose, CA (US); Raymond R. SCHNULLE, San Jose, CA (US); Thomas E. CRAMER, JR., San Jose, CA (US)

(21) Appl. No.: 13/924,582

(22) Filed: Jun. 23, 2013

(51) Int. Cl. G06Q 30/00

(52) U.S. Cl. CPC G06Q 30/0185
USPC 705/318

(57) ABSTRACT

Techniques are provided for managing multiple trusted relationships within a computer product licensing environment. In one example, a partner affiliated with a vendor and a customer of the vendor's products associate with each other. A vendor license manager monitors the license consumption of a customer using the vendor's products and periodically sends a consumption report to a license manager of the associated partner. If a customer's license consumption exceeds the bounds of a given license, the vendor license manager notifies the customer and the partner, and the partner assists the customer in maintaining compliance with the license.

### TECHNICAL FIELD

The present disclosure relates generally to licensing computer software or hardware. More specifically, techniques are disclosed for managing relationships between multiple trusted parties associated with a license for use of computer software and hardware.

### BACKGROUND

Traditionally, licenses for computer software and hardware have been provided to end-user customers via a product activation key (PAK). A PAK is a code, ordered in the same manner as computer equipment for example, that a customer uses to enable, activate, or access features on computer products. The customer associates a PAK with a specific software product (or hardware device). Accordingly, the customer proves product ownership directly for every single software installation instance on a hardware device, as well as for the hardware device itself. For example, a user may activate a network router by keying in a PAK. This licensing approach delegates decisions to enforce the software license into the hardware device (e.g., switch, router, etc.).

However, as more enterprises begin scaling operations, the traditional licensing approach becomes cumbersome and impractical. For example, a customer may license, from a vendor, many instances of a software product, such as a virtual switch to run in a datacenter. The customer receives license PAKs for the software for use on the virtual switches. If the customer wishes to use more virtual switch instances, the customer may have to carry out many different licensing processes, most following a restrictive model that requires significant human intervention (e.g., customer manually installing different PAKs for each software instance). Typically, under the traditional computer product licensing model, the time it takes from a customer placing an order for a computer product to actually activating the product with proper licensing can take weeks. This creates a disadvantage for customers (e.g., scaling enterprises) that need to be able to provision computer products within seconds.

Further, the traditional computer product licensing model lacks meaningful channel partner involvement. Some vendors do not sell computer products directly to the customer for various reasons (e.g., the vendor is so large that selling products directly to the customer is not feasible; the vendor is not able to sell products to customers in a particular country, etc.). Instead, an affiliated partner fulfills direct orders with the customer. Thus, because the vendor and customer typically do not have a direct commerce relationship with each other, the vendor cannot easily manage software or hardware licenses associated with the customer. Presently, involving a partner to manage the customer's licenses for the vendor is difficult because customers may purchase the vendor's products from multiple partners and also, vendors may have no way of knowing from which partner the customer purchased products.

### BRIEF DESCRIPTION OF THE DRAWINGS

So that the manner in which the above-recited features of the present disclosure can be understood in detail, a more particular description of the disclosure, briefly summarized above, may be had by reference to embodiments, some of which are illustrated in the appended drawings. It is to be noted, however, that the appended drawings illustrate only typical embodiments of this disclosure and are therefore not to be considered limiting of its scope, for the disclosure may admit to other equally effective embodiments.

FIG. 1 illustrates relationships between trusted parties in a computer product license environment, according to one embodiment.

FIG. 2 illustrates an example account of a customer enrolled in the trust model, according to one embodiment.

FIG. 3 illustrates a conceptual diagram of associating a channel partner to a customer account, according to one environment.

FIG. 4 illustrates a method of monitoring a customer's license consumption in the trust model of the example licensing environment, according to one embodiment.

FIG. 5 illustrates a method for including a designated partner in handling the license consumption overage of a customer, according to one embodiment.

FIG. 6 illustrates a server computing system of a vendor, according to one embodiment.

FIG. 7 illustrates a server computing system of a partner, according to one embodiment.

### DESCRIPTION

### Overview

One embodiment presented herein includes a method. This method may generally include receiving, at a license manager module of a vendor, information indicating a current customer use for one or more licensed features of computer products licensed by the vendor and registered with the vendor by a customer. This method may also include identifying a set of one or more license entitlements owned by the customer. The method may include determining whether the identified set of license entitlements is adequate for the current customer use. Upon determining that the identified set of license entitlements is inadequate, a customer-designated partner of the vendor is notified of non-compliance.

Another embodiment presented herein includes a method. This method may generally include receiving, from a customer, a selection of a partner from a plurality of partners of a vendor of computer products; prompting the partner to accept the selection. Upon receiving an acceptance from the partner, the selected partner is provided access to account information of the customer, wherein the account information identifies a set of one or more entitlements for computer products licensed to the customer by the vendor.

In a particular embodiment, this method may further include receiving information indicating customer use for each of the computer products licensed to the customer by the vendor and retrieving the license entitlements for the computer product from one of the one or more license pools. Upon determining the customer use does not comply with license requirements based on the license entitlements, the selected partner is notified of the non-compliance.

Other embodiments include, without limitation, a computer-readable medium that includes instructions that enable a processing unit to implement one or more aspects of the disclosed methods as well as a system having a processor, memory, and application programs configured to implement one or more aspects of the disclosed methods.

### Description of Example Embodiments

Embodiments presented herein provide techniques for managing trusted relationships among multiple parties associated with a license for a computer product (e.g., software and/or hardware). In one embodiment, a customer and channel partners of a vendor opt-in to a trust program with the vendor. A vendor license manager device queries the customer to designate a channel partner to act on the vendor's behalf in reconciling the customer's consumption of the vendor's computer product licenses or other managed entitlements. The customer interacts with the license manager to select a preferred channel partner (or partners). Once the vendor license manager receives the selection, the license manager queries the partner. If the partner, through a license manager device on a partner server (or on a server on the vendor cloud), agrees to act as the customer's associated partner, the vendor license manager associates the partner with the customer account and shares the account information with the partner. The vendor license manager periodically reports consumption data of the customer to the partner license manager to track whether a customer is consuming beyond what the license entitles. In the case of such an overage, the vendor license manager initiates one or more management workflows that allow the customer to return to compliance with the vendor.

Embodiments provide a trust model in a computer product licensing program where a customer and a partner of a vendor enter into an agreement with the vendor. Under this model, a customer purchases computer products (e.g., computer software or hardware) and agrees to allow the vendor to track and report on the use of licenses or other entitlements related to the products (e.g., through a license manager in the product or on a vendor-side server). A license manager device generates a customer account associated with the purchases. The customer account includes pools of licenses for the computer products. The license pools include entitlements that specify privileges the customer receives with respect to product use. Under this model, the customer is allowed to temporarily exceed license entitlements within a defined grace period. Once the vendor associates a partner to the customer account, the partner, on a periodic basis, receives data from the vendor that allows the partner to help the customer maintain compliance.

Advantageously, by associating a partner to a customer to manage the customer account and audit and track consumption overages, the vendor is not required to manage every license on an installation-by-installation basis. Further, allowing the partner to access the customer's license entitlement and consumption data enables the partner to assist the customer in complying with associated licenses as well as provides the partner with pursuable sales opportunities. Additionally, this approach allows a customer account to temporarily exceed license entitlements, allowing the customer to quickly provision computer products, e.g., additional software instances, on-demand. The vendor allows the customer to consume a product with appropriate protection and data transparency.

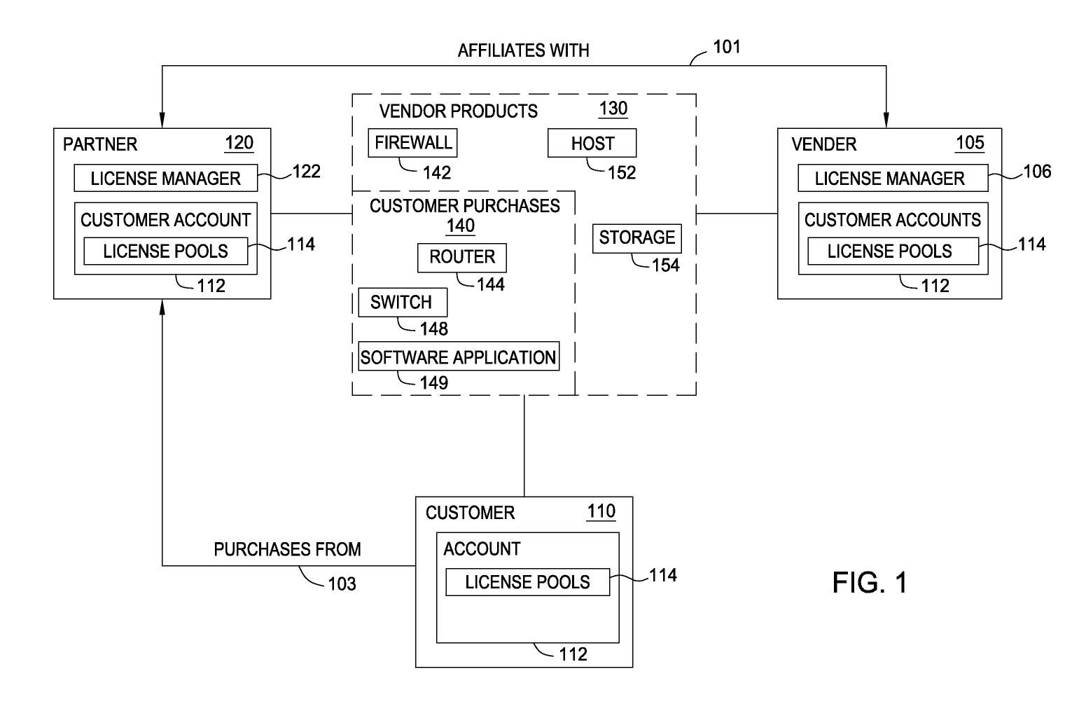

FIG. 1 illustrates a conceptual diagram of the relationships between trusted parties in a computer product license environment, according to one embodiment. The trust model includes a vendor 105, a customer 110, and a partner 120, wherein all parties have agreed to enter into a trust model.

As shown, vendor 105 has computer products 130 available for purchase that are sold through a partner 120 with whom vendor 105 affiliates (represented by the two-way arrowed line at 101). For example, computer products 130 may include a firewall 142, a router 144, a switch 148, software application 149, a host 152 (e.g., a server), and a storage 154, among other products. Customer 110 purchases one or more computer products from partner 120 (represented by the one-way arrow line at 103). In this example, the customer purchases 140 include a router 144, a switch 148, and a software application 149. Partner 120 sends the computer products to customer 110. If partner 120 is a designated partner for customer 110 (explained in further detail below), partner 120 also associates the products with a license manager 122 running in a server computing system of partner 120. Alternatively, the partner license manager 122 may also reside in memory of a server computing system located on the vendor cloud.

A license manager 106 residing in memory of a server computing system of vendor 105 may monitor the usage of computer purchases 140 once customer 110 activates the computer purchase with the license manager 106. To activate a computer product, customer 110 registers the computer purchase 140 with license manager 106. A registration of a purchase 140 may include an identifier of a product (or instance of the product). After the license manager 106 receives purchase records and the product registrations, the license manager 106 associates the registration with a license pool 114. Once registered, the license manager may monitor the license consumption by customer 110 for each product.

In one embodiment, computer purchases 140 are associated with a customer account 112. Customer account 112 may include license pools 114. A license pool 114 is a logical grouping of software licenses and product instances associated with customer account 112. License manager 106 is responsible for ensuring that the consumption remains within the license entitlements. A license entitlement, as explained in greater detail below, provides a set of privileges received when purchasing a license.

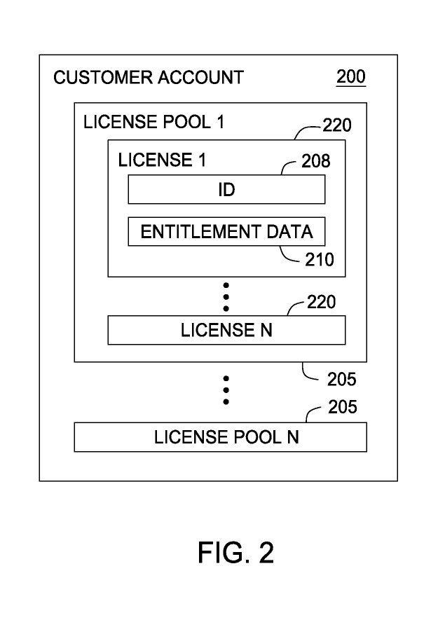

FIG. 2 further illustrates a customer account 200, according to one embodiment. Illustratively, customer account 200 may include one or more license pools 205. As stated, a license pool 205 is a grouping of licenses and product instances 220. In one embodiment, a license pool 205 may be categorized by product line. For example, a license pool 205 may correspond to a group of licenses for datacenter products, while another license pool 205 may correspond to a group of licenses for telecommunications products. More generally, each license pool may relate to a common set of software products.

Each license 220 includes an identifier 208 and entitlement data 210. An entitlement is a set of privileges associated with a particular computer software or hardware license. Examples of entitlement data 210 may include the right to use software or access software subscriptions, to enable specific features of a hardware/software product, specify a number of installation instances (or “seats”) for a software application, specify content that the customer may access, upgrades that the customer may make, the duration that the customer is allowed to use the product, among other rights. For example, license entitlement data 210 for a software-based (i.e., virtual) router may specify that the customer is allowed to have up to five open ports. As another example, license entitlement data 210 of a firewall may specify that a customer can have up to ten connected devices per firewall. In one embodiment, entitlement data 210 is dynamic. That is, if a customer, for example, makes additional purchases of a software instance or decommissions end-devices, the entitlement data 210 changes to reflect the additions, deletions, etc.

If the license consumption of a customer exceeds entitlement data 210, an overage situation occurs. For example, a customer might exceed license consumption if the customer uses a certain product beyond a limited duration specified by the license. As another example, overage might occur if the customer provisions more instances of a software product than entitled. In one embodiment, the vendor may set an overage allowance and a period by which the customer should return to compliance. In addition, a customer may also set an overage allowance within a vendor-specified limit for each license pool 205.

Under the trust model, when an affiliated partner sells a vendor's product to a customer, the partner gains access to entitlement data 210 in the license pool corresponding to the particular product. In one embodiment, a partner associated with a particular customer account 200 may access the customer's aggregate license pool data. For example, if three different partners A, B, and C sell virtual switches to the customer, the customer's license pool may include license information of the virtual switches from each partner. Although A, B, and C may access the license pool 205, each partner can access only the licenses 220 and entitlement data 210 for the virtual switches sold by the given partner (e.g., only A can see the entitlement data for virtual switches that A sold to the customer but not for the virtual switches sold by B). However, if customer decides to associate with partner A in the trust model, then partner A becomes privy to the customer's entitlements from virtual switches purchased from partners B and C. Access to such past entitlements may present an added incentive for a partner to agree to associate with a customer.

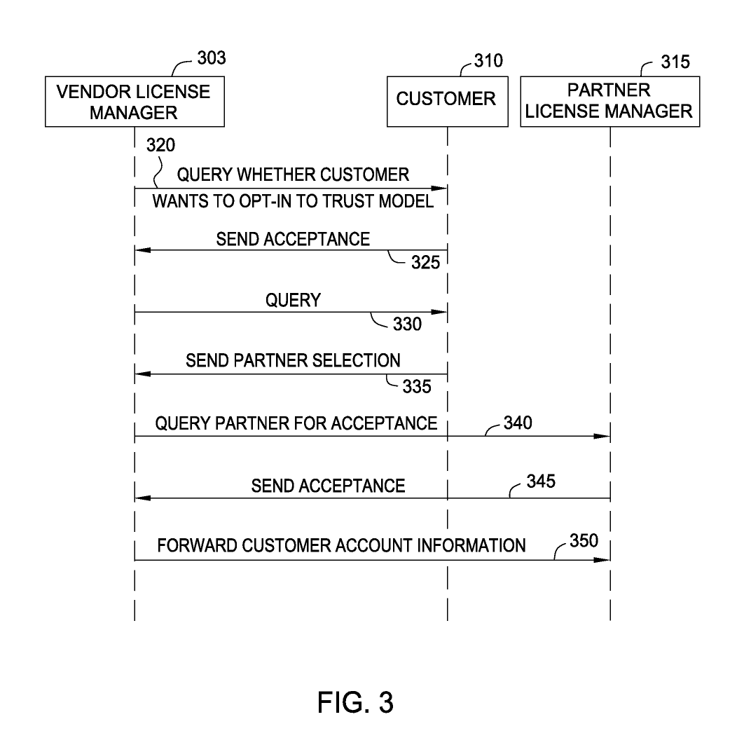

FIG. 3 illustrates a conceptual diagram of a process to associate a channel partner with a customer account, according to one embodiment. The process shown in FIG. 3 involves a vendor 305, a customer 310, and a partner 315. Assume that a group of channel partners have agreed to participate in the trust model with the vendor. The vendor, through a license manager device, queries customer 310 asking whether customer 310 agrees to participate in the trust model (at 320). In one embodiment, vendor 305 may present the query as a click-to-accept agreement during the registration process of a purchased product through a software application. The agreement specifies obligations of the vendor 305 and customer 310. For example, by entering into the trust model, customer 310 may create an affirmative obligation with the vendor 305 to pay for and license the computer products of vendor 305 that customer 310 is using. As another example, if the customer is an indirect customer of a vendor (i.e., the customer purchases the vendor's products from a partner instead of directly from the vendor), the agreement may require the customer to associate a license manager with an affiliate partner.

Customer 310 accepts (at 325). In one embodiment, after customer 310 enters the trust model, vendor 305 may query customer 310 to assign a partner 315 to associate with licenses pools (at 330). Customer 305 sends the selection of a partner 315 to vendor 305. Vendor 305 queries the selected partner 315 to determine whether partner 315 agrees to be the associated partner of customer 310 (at 340). If partner 315 agrees, partner 315 sends the acceptance to vendor 305 (at 345).

After partner 315 agrees to be the associated partner, vendor 305 sends account information of customer 310 to partner 315 (at 350). In one embodiment, the account information includes aggregate license pool and entitlement data associated with the purchases of customer 310. The account information includes the entitlement data of related purchases from other partners. Further, on a periodic basis, vendor 305 sends partner 315 status reports of the license consumption of customer 310. Partner 315 may use the status reports to generate pricing quotes and ensure that customer 310 does not exceed the license entitlements (or ensure that customer 310 comes into compliance if customer 310 exceeds the entitlements).

Note that selecting a partner does not create an obligation for customer 305 to purchase vendor 305's products directly from that partner. However, as stated, partner 315 may have access to past and subsequent entitlements purchased from other partners. This allows partner 315 to manage customer 310's license consumption of vendor 305's products as well as provides sales opportunities for partner 315.

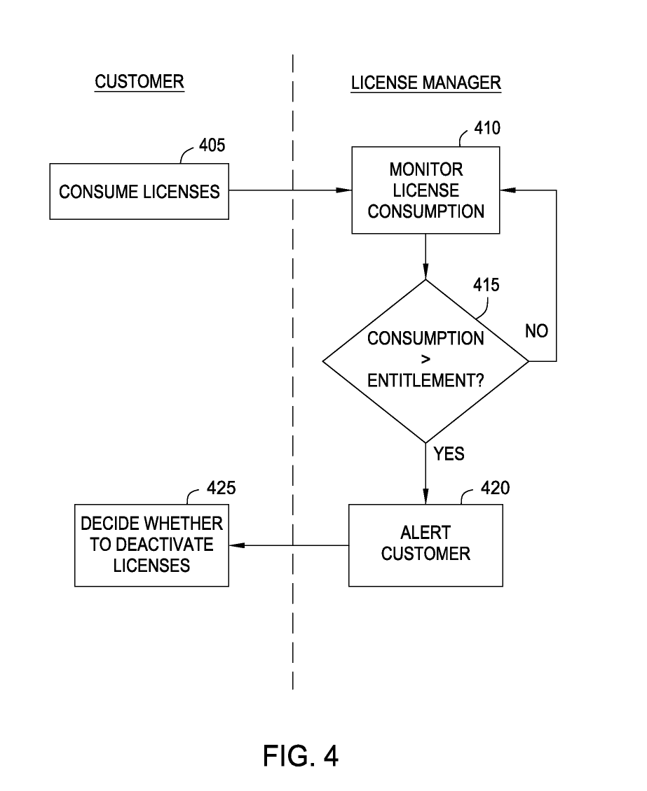

FIG. 4 illustrates a method 400 of a monitoring a customer's license consumption in the trust model of the example licensing environment, according to one embodiment. In one embodiment, a license manager residing in a server computing system of the vendor monitors and tracks the customer's usage of the purchased products for whether the customer is using the products within the license entitlements. The method begins at step 405 with the customer using the purchased product. For example, the customer may be using one hundred instances of a virtual router as licensed from the vendor. At step 410, the vendor license manager monitors the customer's use.

Should the customer exceed the entitlements of the given license pool (at 415), the vendor license manager alerts the customer (at 420). Continuing the previous example, assume the customer provisions ten more virtual router instances than there are available entitlements for the virtual router in the relevant license pool. As a result, the customer's usage is exceeding the entitlements. At this point, the vendor may notify a designated contact within the customer about the overage situation. Doing so allows the customer the opportunity to deauthorize or disengage the software to return to compliance (or purchase additional entitlements). At step 425, the customer may decide whether to come back into compliance. Under the trust licensing model, the customer may choose to remain in an overage situation for a temporary period of time defined by the vendor or the computer product license. This period allows the customer to quickly provision additional instances of a computer product when needed and pay for the product later.

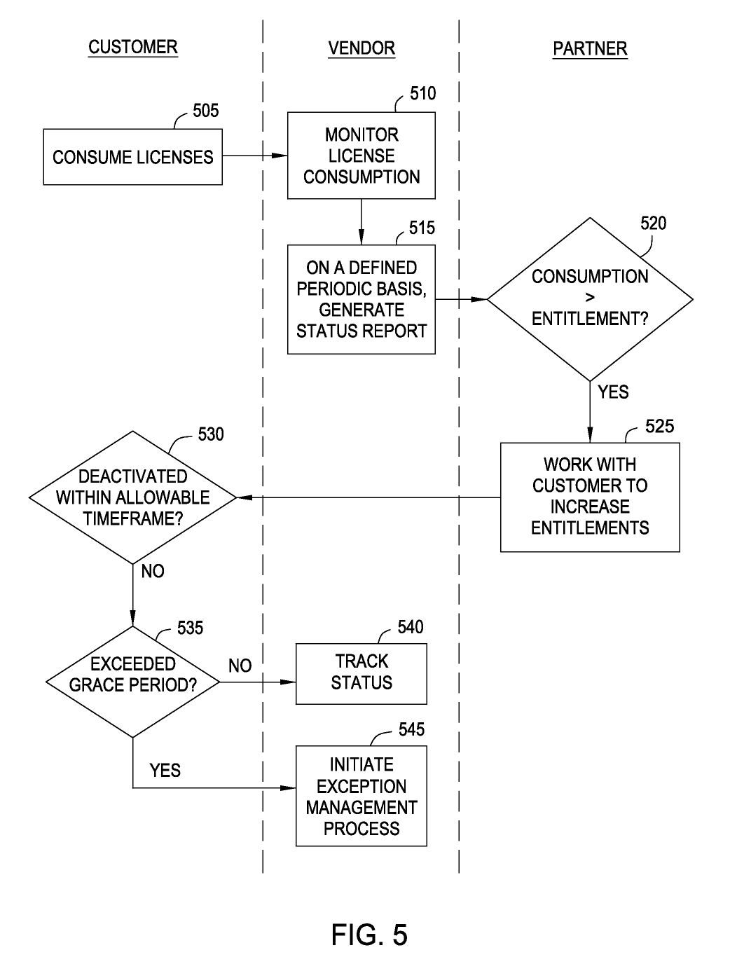

As stated, the customer may choose to remain in an overage situation for a defined period of time. In one embodiment, the vendor, through the license manager device, may notify the partner of the customer's overage to try and get the customer to purchase additional entitlements. FIG. 5 illustrates a method of including a designated partner in handling the license consumption overage of a customer, according to one embodiment. The method begins at 505, where the customer uses the purchased computer products. The vendor, through a license manager device, monitors the customer's usage (at 510) for whether the customer is using the product within the bounds of the license entitlements. Although the vendor license manager notifies the customer whenever the license manager detects an overage, in one embodiment, the license manager, on a defined periodic basis, generates a status report of the customer's usage to forward to the partner designated to handle the customer account (at 515). The partner, through a corresponding license manager device on a server computing system, uses the status report to determine whether the customer is consuming the license beyond the license entitlements (at 520). For instance, a customer might exceed license consumption by using software past an agreed-upon duration, using more than the allowed features, using a newer version than the version at activation, etc.

Continuing the previous example, assume that the customer initially licenses one hundred instances of a virtual router software product and is running ten additional instances beyond the entitlements. The vendor notifies both the customer and the partner of the overage through the status report. If the customer is exceeding entitlements for a given license, then the partner assists the customer in complying with the trust model (at 525). To maintain compliance, the customer has the option to scale back license consumption (e.g., by deactivating the computer product within an allowable defined timeframe) or acquire additional license entitlements. Because the vendor may be unlikely to have a direct sales relationship with the customer, this approach may provide an incentive for the partner to persuade the customer to purchase additional entitlements.

Otherwise, if the customer chooses to remain in overage and has not deactivated within the allowable timeframe (at 530), the customer has a grace period (defined by the vendor) by which to comply with the trust model (at 535). During the grace period, the vendor, through the license manager, tracks the status of the overage to determine whether the customer has come into compliance within the period (at 540). If the customer has exceeded the grace period, however, the vendor initiates an exception management process (at 545). In one embodiment, the vendor may notify the customer and the partner of the overage and give the customer another opportunity to remedy the non-compliance and return to good standing within the trust model. At this point, the customer has the opportunity to increase entitlements or transfer entitlements (e.g., to a license pool that can accommodate the usage) within a defined timeframe. Past this timeframe, and once the vendor and the partner have exhausted all other remedies, then the vendor ejects the customer from the trust model and may relegate the customer to a traditional licensing model (e.g., by requiring that the customer use a product activation key (PAK) to operate the software).

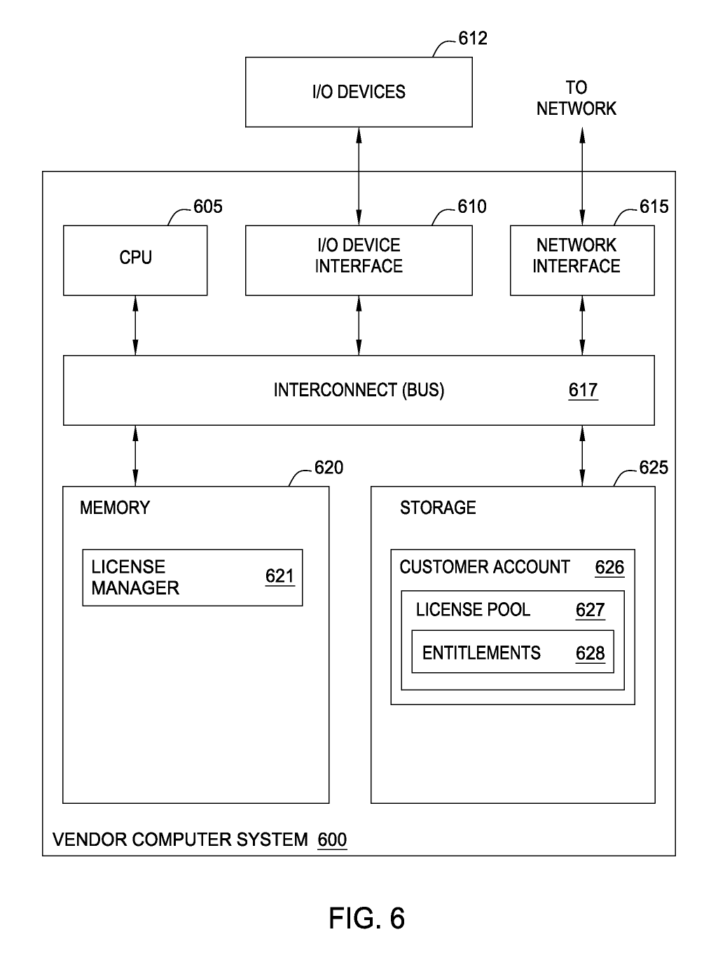

FIG. 6 illustrates a server computing system 600 of a vendor in the example licensing environment configured with a license manager, according to one embodiment. As shown, server computing system 600 includes, without limitation, a central processing unit (CPU) 605, an I/O device interface 610, a network interface 615, a memory 620, and a storage 625, each connected to a bus 617. The I/O device interface 610 connects I/O devices 612 (e.g., keyboard, display, and mouse devices) to server computing system 600. Further, in context of this description, the computing elements shown in server computing system 600 may correspond to a physical computing system (e.g., a system in a data center) or may be a virtual computing instance executing within a cloud computing environment.

The CPU retrieves and executes programming instructions stored in memory 620 and stores and retrieves application data residing in storage 625. Via bus 617, server computing system 600 transmits programming instructions and application data between CPU 605, I/O devices 610, storage 625, network interface 615, and memory 620. Note that CPU 605 is included to be representative of a single CPU having multiple processing cores, and/or the like. Memory 620 is included to be generally representative of a random access memory. Storage 625 may be a disk drive storage device. Although shown as a single unit, storage 625 may be a combination of fixed and/or removable storage devices, such as fixed disc drives, removable memory cards, or optical storage, network attached storage (NAS), or a storage area network (SAN).

Server computing system hosts license manager 621 and license pool(s) 627 of a customer account 626. License manager 621 resides in memory 620. Storage 625 includes customer account information 626, which in turn includes license pool(s) 627 associated with license manager 621. License manager 621 communicates directly with the computer products that a customer has purchased and monitors the customer's consumption of the license to ensure that the consumption is within the bounds of specified license entitlements. Additionally, license manager 621 may report the usage to the customer's associated partner on a periodic basis. License manager 621, in communicating with a partner license manager, acts as a single source of truth for tracking entitlement data and customer usage.

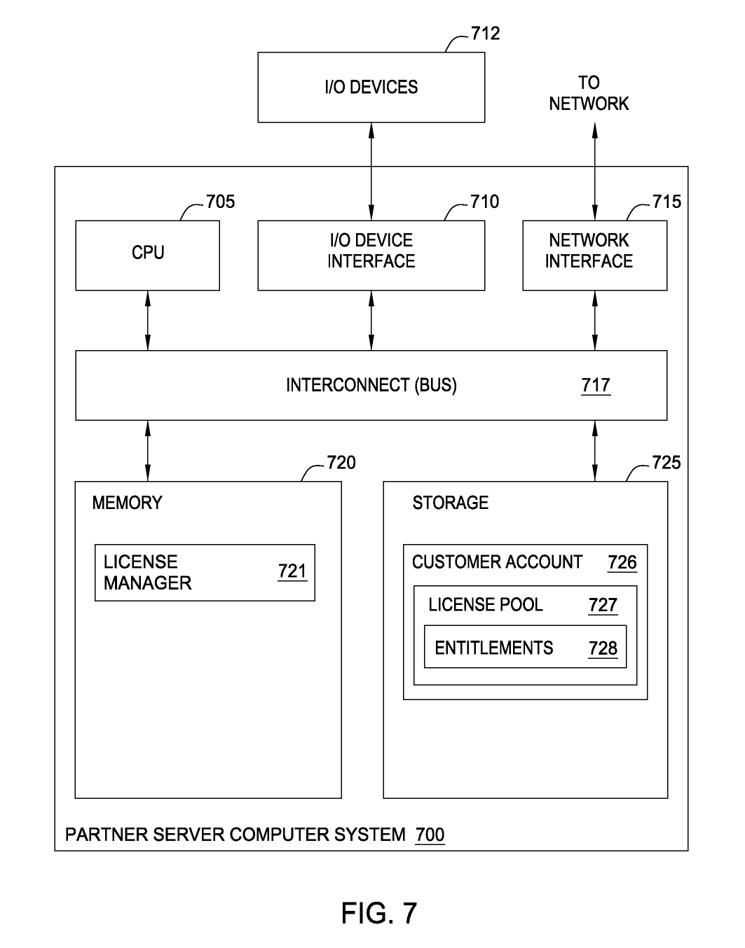

FIG. 7 illustrates a server computing system 700 of a channel partner in the example licensing environment that is configured to manage the license consumption of a customer account, according to one embodiment. Partner server computing system 700 can reside on a network connected to the vendor license manager. Alternatively, server computing system 700 can be hosted on a vendor cloud network. As shown, server computing system 700 includes, without limitation, a central processing unit (CPU) 705, an I/O device interface 710, a network interface 715, a memory 720, and a storage 725, each connected to a bus 717. The I/O device interface 710 connects I/O devices 712 (e.g., keyboard, display, and mouse devices) to server computing system 700. Further, in context of this description, the computing elements shown in server computing system 700 may correspond to a physical computing system (e.g., a system in a data center) or may be a virtual computing instance executing within a cloud computing environment.

The CPU retrieves and executes programming instructions stored in memory 720 and stores and retrieves application data residing in storage 725. Via bus 717, server computing system 700 transmits programming instructions and application data between CPU 705, I/O devices 710, storage 725, network interface 715, and memory 720. Note that CPU 705 is included to be representative of a single CPU having multiple processing cores, and/or the like. Memory 720 is included to be generally representative of a random access memory. Storage 725 may be a disk drive storage device. Although shown as a single unit, storage 725 may be a combination of fixed and/or removable storage devices, such as fixed disc drives, removable memory cards, or optical storage, network attached storage (NAS), or a storage area network (SAN).

Server computing system hosts license manager 721 and license pool(s) 727 of a customer account 726. Partner license manager 721 resides in memory 720. Storage 725 includes customer account information 726, which in turn includes license pool(s) 727 associated with license manager 721. License manager 721 communicates with the license manager of a vendor server computing system (e.g., license manager 621). As stated, the vendor license manager acts as a single source of truth for tracking license entitlement usage. As a result, partner license manager 721 interacts with the vendor license manager for actual license usage permission. Further, on a periodic basis, the vendor license manager sends status reports of an associated customer's license consumption of a particular product to license manager 721. License manager 721 compares the reported consumption against the provided license entitlements located in license pool 727.

While the foregoing is directed to embodiments of the present disclosure, other and further embodiments of the disclosure may be devised without departing from the basic scope thereof. For example, aspects of the present disclosure may be implemented in hardware, software, or a combination of hardware and software. One embodiment of the disclosure may be implemented as a program product for use with a computer system. The program(s) of the program product define functions of the embodiments (including the methods described herein) and can be contained on a variety of computer-readable storage media. Illustrative non-transitory computer-readable storage media include, but are not limited to: (i) non-writable storage media (e.g., read-only memory devices within a computer such as CD-ROM disks readable by a CD-ROM drive, flash memory, ROM chips or any type of solid-state non-volatile semiconductor memory) on which information is permanently stored; and (ii) writable storage media (e.g., a hard-disk drive or any type of solid-state random-access semiconductor memory) on which alterable information is stored. Such computer-readable storage media, when carrying computer-readable instructions that direct the functions of the present disclosure, are embodiments of the present disclosure.

Although certain embodiments may achieve advantages over other possible solutions and/or over the prior art, whether a particular advantage is achieved by a given embodiment is not limiting. Thus, the following aspects, features, embodiments and advantages are merely illustrative and are not considered elements or limitations of the appended claims except where explicitly recited in a claim(s).

Aspects of the present disclosure may be embodied as a system, method or computer program product. Accordingly, embodiments presented herein may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples a computer readable storage medium include: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the current context, a computer readable storage medium may be any tangible or otherwise non-transitory medium that can contain, or store a program for use by or in connection with an instruction execution system, apparatus or device.

The flowchart and block diagrams in the Figures illustrate the architecture, functionality, and operation of possible implementations of systems, methods, and computer program products according to various embodiments presented herein. In this regard, each block in the flowchart or block diagrams may represent a module, segment or portion of code, which comprises one or more executable instructions for implementing the specified logical function(s). In some alternative implementations the functions noted in the block may occur out of the order noted in the figures. For example, two blocks shown in succession may, in fact, be executed substantially concurrently, or the blocks may sometimes be executed in the reverse order, depending upon the functionality involved. Each block of the block diagrams and/or flowchart illustrations, and combinations of blocks in the block diagrams and/or flowchart illustrations can be implemented by special-purpose hardware-based systems that perform the specified functions or acts, or combinations of special purpose hardware and computer instructions.

Embodiments disclosed herein may be provided to end users through a cloud computing infrastructure. Cloud computing generally refers to the provision of scalable computing resources as a service over a network. More formally, cloud computing may be defined as a computing capability that provides an abstraction between the computing resource and its underlying technical architecture (e.g., servers, storage, networks), enabling convenient, on-demand network access to a shared pool of configurable computing resources that can be rapidly provisioned and released with minimal management effort or service provider interaction. Thus, cloud computing allows a user to access virtual computing resources (e.g., storage, data, applications, and even complete virtualized computing systems) in “the cloud,” without regard for the underlying physical systems (or locations of those systems) used to provide the computing resources. A user can access any of the resources that reside in the cloud at any time, and from anywhere across the Internet.

In view of the foregoing, the scope of the present disclosure is determined by the claims that follow.

What is claimed is:

1. A computer-implemented method, comprising:
receiving, at a license manager module of a vendor, information indicating a current customer use for one or more licensed features of computer products licensed by the vendor and registered with the vendor by a customer;
identifying a set of one or more license entitlements owned by the customer;
determining whether the identified set of license entitlements is adequate for the current customer use; and
upon determining that the identified set of license entitlements is inadequate, notifying a customer-designated partner of the vendor of non-compliance.

2. The method of claim 1, wherein the notification prompts the partner to prompt the customer to acquire additional license entitlements as needed to comply.

3. The method of claim 2, further comprising:
receiving the additional license entitlements acquired by the customer; and
provisioning the additional license entitlements to the identified set of license entitlements.

4. The method of claim 1, wherein the set of one or more license entitlements includes license entitlements acquired by the customer from a plurality of partners of the vendor.

5. The method of claim 1, wherein the vendor provides the customer-designated partner with entitlement information corresponding to the customer.

6. The method of claim 1, further comprising, notifying the computer product of the non-compliance.

7. The method of claim 6, wherein the computer product, in response to the notification of non-compliance, modifies the features of the computer product after a predefined time period.

8. A non-transitory computer-readable storage medium storing code for execution by a processor, wherein the code, when executed by the processor, performs an operation, the operation comprising:
receiving, at a license manager module of a vendor, information indicating a current customer use for one or more licensed features of computer products licensed by the vendor and registered with the vendor by a customer;
identifying a set of one or more license entitlements owned by the customer;
determining whether the identified set of license entitlements is adequate for the current customer use; and
upon determining that the identified set of license entitlements is inadequate, notifying a customer-designated partner of the vendor of non-compliance.

9. The computer-readable storage medium of claim 8, wherein the notification prompts the partner to prompt the customer to acquire additional license entitlements as needed to comply.

10. The computer-readable storage medium of claim 9, wherein the operation further comprises:
receiving the additional license entitlements acquired by the customer; and
provisioning the additional license entitlements to the identified set of license entitlements.

11. The computer-readable storage medium of claim 8, wherein the set of one or more license entitlements includes license entitlements acquired by the customer from a plurality of partners of the vendor.

12. The computer-readable storage medium of claim 8, wherein the vendor provides the customer-designated partner with entitlement information corresponding to the customer.

13. The computer-readable storage medium of claim 8, wherein the operation further comprises, notifying the computer product of the non-compliance.

14. The computer-readable storage medium of claim 13, wherein the computer product, in response to the notification of non-compliance, modifies the features of the computer product after a predefined time period.

15. A system, comprising:
a processor; and
a memory hosting an application, which, when executed on the processor, performs an operation, the operation comprising:
receiving, at a license manager module of a vendor, information indicating a current customer use for one or more licensed features of computer products licensed by the vendor and registered with the vendor by a customer;
identifying a set of one or more license entitlements owned by the customer;
determining whether the identified set of license entitlements is adequate for the current customer use; and
upon determining that the identified set of license entitlements is inadequate, notifying a customer-designated partner of the vendor of non-compliance.

16. The system of claim 15, wherein the notification prompts the partner to prompt the customer to acquire additional license entitlements as needed to comply.

17. The system of claim 15, wherein the set of one or more license entitlements includes license entitlements acquired by the customer from a plurality of partners of the vendor.

18. The system of claim 15, wherein the vendor provides the customer-designated partner with entitlement information corresponding to the customer.

19. The system of claim 15, wherein the operation further comprises, notifying the computer product of the non-compliance, and wherein the computer product, in response to the notification of non-compliance, modifies the features of the computer product after a predefined time period.

20. A computer-implemented method, the method comprising:
receiving, from a customer, a selection of a partner from a plurality of partners of a vendor of computer products;
prompting the partner to accept the selection; and
upon receiving an acceptance from the partner, providing the selected partner with access to account information of the customer, wherein the account information identifies a set of one or more license entitlements for computer products licensed to the customer by the vendor.

21. The method of claim 20, further comprising:
receiving, at a license manager module of the vendor, information indicating current customer use for one or more licensed features of the computer products licensed to the customer by the vendor;
determining whether the identified set of license entitlements is adequate for the current customer use; and
upon determining that the identified set of license entitlements is inadequate, notifying the selected the partner of non-compliance.
